(19) United States
(12) Patent Application Publication
(10) Pub. No.: US 2015/0342175 A1
(43) Pub. Date: Dec. 3, 2015

(54) ORGAN AND TISSUE PRESERVATION FORMULATIONS WITH INCREASED STABILITY AND SHELF LIFE

(71) Applicant: SOMAHLUTION, LLC, Jupiter, FL (US)

(72) Inventors: Mahendra Suryan, Wellington, FL (US); Satish Menon, Jupiter, FL (US)

(73) Assignee: SOMAHLUTION, LLC, Jupiter, FL (US)

(21) Appl. No.: 14/654,168

(22) PCT Filed: Dec. 27, 2013
(86) PCT No.: PCT/US13/78052

§ 371 Date: Jun. 19, 2015

Related U.S. Application Data
(60) Provisional application No. 61/848,350, filed on Dec. 31, 2012.
(60) Provisional application No. 61/848,349, filed on Dec. 31, 2012.

(51) Int. Cl. A01N 1/02

(52) U.S. Cl. CPC A01N 1/0226; A01N 1/0242

(57) ABSTRACT

Organ and tissue preservation formulations with improved stability shelf life are provided by separating the formulation into a first solution having a pH of at least 7 and a second solution having a pH of less than 7. The first solution includes components with improved stability when stored at a pH of 7 or above, and the second solution includes components with improved stability when stored at a pH below 7. The first solution includes water, a balanced salt solution, a sugar, adenosine, orotic acid, malic acid, L-carnitine, and insulin. The second solution includes water, an antioxidant such as ascorbic acid, a cellular reducing agent such as reduced glutathione, L-citrulline, creatine monohydrate, L-carnosine, and L-arginine. During use, the first and second solutions are mixed to form a formulation final formulation that can be used at a physiological pH to preserve the function of the tissue or organ.

### RELATED APPLICATION

This application claims the benefit of and priority to prior filed pending Provisional Application Ser. Nos. 61/848,350 and 61/848,349, both filed Dec. 31, 2012, the disclosures of which are hereby incorporated herein by reference in their entirety.

### FIELD

The present invention is directed to formulations for preserving tissue and organ function and more particularly to shelf stable formulations for preserving tissue and organ function prior to implantation.

### BACKGROUND

Tissues and organs for implantation or transplantation in a subject are stored extra-corporeally in liquid formulations that preserve the function of the tissues and organs until implantation. Tissue and organ preserving formulations are known. One formulation of interest is described in U.S. Pat. No. 8,211,628, which is incorporated by reference in its entirety. The tissue and organ preserving formulation described in U.S. Pat. No. 7,981,596 is generally referred to in the literature as the Lazarus formulation. More recently another tissue and organ preserving formulation generally referred to as Somah was described in Circulation 120: 1704-1713 (2004). The shelf lives of the Lazarus and Somah formulations are limited due to the instability of various components of the formulations. The relatively short shelf lives of the Lazarus and Somah formulations can limit their usefulness. Thus, there is a need to improve the Lazarus and Somah formulations to improve the stability of their components and thereby lengthen the shelf lives of the formulations.

### SUMMARY

The present invention relates to organ and tissue preservation solutions also referred to as Lazarus and Somah formulations having improved stability and increased shelf life when compared to the original formulations. Also described are methods of using the improved formulations.

According to the present invention, Lazarus and Somah formulations with extended shelf lives can be prepared by forming a first solution having a pH of at least 7 and a second solution having a pH of less than 7. The first solution includes components with improved stability when stored at a pH of 7 or above, and the second solution includes components with improved stability when stored at a pH below 7. The first solution includes water, a balanced salt solution, a sugar such as D-glucose, mannose, and fructose, adenosine, orotic acid, malic acid, L-carnitine, and insulin at a pH of at least 7 and preferably at a pH that ranges from pH 7 to about pH 9. The first solution may optionally include sodium dicholoroacetate. Formulations intended for use with cardioplegia may also include an additional amount of KCL in the first solution. The second solution includes water, an antioxidant such as ascorbic acid, a reducing agent such as reduced glutathione, L-citrulline, creatine, L-carnosine, and L-arginine at a pH of less than 7.0 and preferably from pH 6.8 to about pH 6.4. At the point of use, the first and second solutions are mixed together to form a final formulation that can be used at a physiological pH of around pH 7.4 to preserve the function of the tissue or organ.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a perspective view of a multi-chamber bag in accordance with embodiments of the invention.

FIG. 2 is a perspective view of a kit having a first container and a second container in accordance with embodiments of the invention.

### DETAILED DESCRIPTION

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described. For the purposes of the present invention, the following terms are defined below.

As used herein, “organ” includes, but is not limited to, the heart, veins, arteries, lungs, liver, pancreas, and the kidneys. Portions of organ are also contemplated.

As used herein, “sterile water” includes but is not limited to, (a) sterile water for injection, USP, (b) sterile distilled deionized water, and (c) sterile water for irrigation.

As used herein, “anitoxidant” is a substance that, when present in a mixture or structure containing an oxidizable substrate biological molecule, delays or prevents oxidation of the substrate biological molecule. For example, ascorbic acid is an antioxidant.

As used herein, “balanced salt solution” is defined as an aqueous solution that is osmotically balanced to prevent acute cell or tissue damage.

As used herein, “physiological solution” is defined as an aqueous salt solution which is compatible with normal tissue by virtue of being isotonic with normal interstitial fluid.

As used herein, “graft” is defined as tissue that is transplanted or implanted in part of the body to repair a defect.

As used herein, “cardioplegia” includes but is not limited to, paralysis of the heart.

As used herein, “cellular reducing agent” is defined as a substance that loses electrons easily thereby causing other substance to be reduced chemically.

Typically, these tissue preservation solutions referred to as Lazarus or Somah will contain water, a balanced salt solution, a sugar, adenosine, orotic acid, malic acid, L-carnitine, an antioxidant such as ascorbic acid and a cellular reducing agent such as glutathione, L-citrulline, creatine monohydrant, L-carnosine and L-arginine.

The stability of the tissue preservation formulations can be improved by separating the formulation into a first solution having a pH of at least 7 and a second solution having a pH of less than 7. The first and second solutions are mixed together to form a final isotonic organ and tissue preservation formulation that can be used at a physiological pH of around pH 7.4 to preserve the function of the tissue or organ.

The first solution includes components with improved stability when stored at a pH of 7.0 or above. The first solution includes water, a balanced salt solution, a sugar such as D-glucose, fructose or mannose, adenosine, orotic acid, malic acid, L-carnitine and insulin. An exemplary embodiment includes about 11 mmol/liter D-glucose, about 2 mmol/liter adenosine, about 0.5 mmol/liter orotic acid, about 1 mmol/liter malic acid, about 10 mmol/liter L-carnitine, 100 units/liter insulin, and about 950 mL water. The first solution may optionally include about 0.5 mmol/liter sodium dicholoroacetate. The balanced salt solution includes salts selected from the following: calcium chloride dihydrate, potassium chloride, potassium phosphate monobasic, magnesium chloride hexahydrate, magnesium sulfate heptahydrate, sodium chloride, sodium bicarbonate, sodium phosphate dibasic heptahydrate and combinations thereof. The balanced salt solution is provided at a concentration that will result in an isotonic solution when the first and second solutions are mixed together. In an exemplary embodiment, the balanced salt solution about 1.3 mmol/liter calcium chloride dihydrate, about 7 mmol/liter potassium chloride, 0.44 mmol/liter potassium phosphate monobasic, about 0.5 mmol/liter magnesium chloride hexahydrate, about 0.5 mmol/liter magnesium sulfate heptahydrate, about 125 mmol/liter sodium chloride, about 5 mmol/liter sodium bicarbonate, and about 0.19 mmol/liter sodium phosphate dibasic heptahydrate. Formulations intended for use with cardioplegia may also include an additional amount of KCL, such as about 15 mmol/liter. Other salts can be used to provide the active ions as long as the final formulation formed from the mixture of the first and second solutions is isotonic.

The first solution may have a pH of at least pH 7.0 and preferably a pH that ranges from pH 7 to about pH 9. In a preferred embodiment, the first solution has a pH of at least pH 8 and preferably the pH is in a range from about pH 8 to about pH 9.

The second solution includes components with improved stability when stored at a pH below 7.0. The second solution includes water, an antioxidant such as ascorbic acid, a cellular reducing agent such as reduced glutathione, L-citrulline, creatine monohydrate, L-carnosine, and L-arginine. The components of the second solution are provided in relative concentrations to result in an isotonic final formulation when the first solution is mixed with the second solution. In an exemplary embodiment, the second solution includes 50 milliliters of water and about 20 mmol/liter reduced L-glutathione, about 20 mmol/liter L-ascorbic acid, about 20 mmol/liter L-citrulline, about 40 mmol/liter creatine monohydrate, about 200 mmol/liter L-carnosine, and about 100 mmol/liter L-arginine. In an alternative exemplary embodiment, the second solution includes 50 milliliters of water and about 1 mmol/liter reduced L-glutathione, about 1 mmol/liter L-ascorbic acid, about 1 mmol/liter L-citrulline, about 2 mmol/liter creatine monohydrate, about 10 mmol/liter L-carnosine, and about 5 mmol/liter L-arginine.

The pH of the second solution is less than 7 and preferably from about pH 6.8 to about pH 6.4. In another preferred embodiment, the pH of the second solution is in a range from about pH 6.5 to about pH 6.7. In another embodiment, the pH of the second solution is about 6.6.

In an exemplary embodiment, the volumetric ratio between the first solution and the second solution is about 19:1. In a preferred embodiment, 950 ml of the first solution is mixed with 50 ml of the second solution to result in the final formulation for preserving the function of a tissue or organ.

The first or second formulations may optionally include an anticoagulant in an amount sufficient to help prevent clotting of blood within the vasculature of a tissue or organ. Exemplary anticoagulants include heparin and hirudin, but other anticoagulants may be used. An exemplary embodiment includes heparin in concentration ranges from about 50 units/liter to about 250 units/liter.

During use, the first and second solutions are mixed together to form a final formulation that can be used at a physiological pH in a range between about pH 7.2 and about pH 7.6 and preferably about pH 7.4, to preserve the function of the tissue or organ. If the mixture of the first and second solutions does not have a physiological pH in a range between about pH 7.2 and about pH 7.6, the pH of the mixture can be adjusted with a base or acid to the physiological pH.

Embodiments of the invention may be provided in a kit wherein the first and second solutions are provided in separate compartments or containers that can be mixed at the point of use to result in the final formulation.

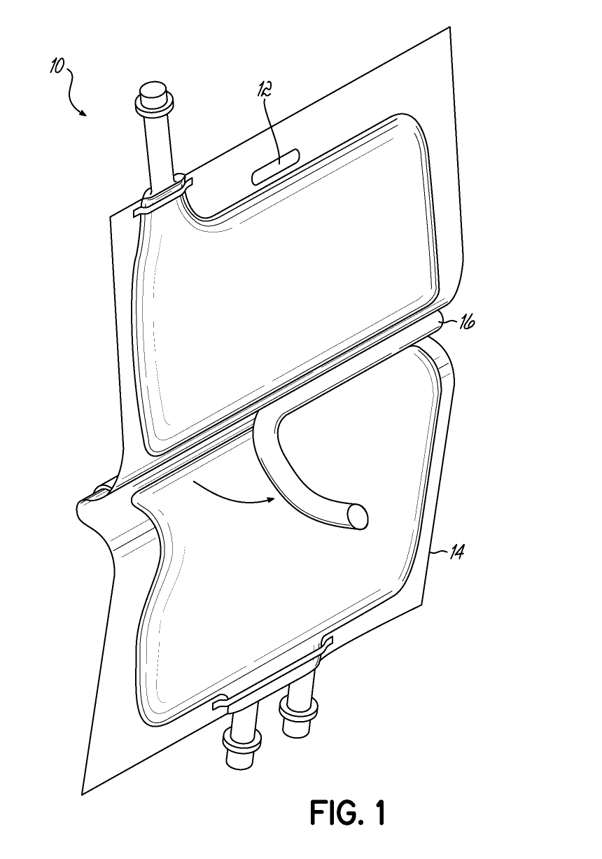

FIG. 1 illustrates a kit including an exemplary container 10 having a first compartment 12 separated from a second compartment 14 by a removable partition that includes a male member 16 and a female member 18. The first solution is maintained in one of the first 12 or second 14 compartments and the second solution is maintained in the other of the first 12 or second 14 compartments. The first and second solutions may be mixed by removing the removable partition, which results in the first and second compartments now forming a single compartment containing the final formulation for preserving tissue function. The mixture can then be used as needed.

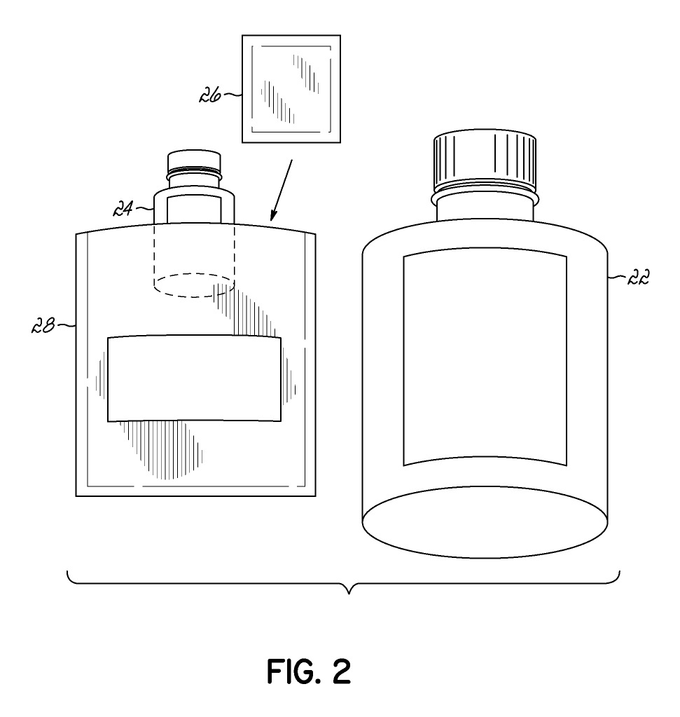

FIG. 2 illustrates an alternative kit having a first container 22 and a second container 24. The first solution is provided in the first container 22 and the second solution is provided in the second container 24. During use, the second solution is transferred from the second container 24 to the first container 22 where the first and second solutions are mixed to form the final formulation for preserving the function of a tissue or organ. The kit may optionally include a preservative, such as an oxygen absorber 26, and a pouch 28 for protecting and optionally storing one or both of the first 22 and second 24 containers. The kit may also optionally include a device, such as a syringe (not shown), for transferring the contents of one of the containers to the other container.

In the embodiment shown in FIG. 2, the first solution is aseptically filled in the first container 24, such as a pre-sterilized Nalgene bottle, which is then secured with a pre-sterilized HDPE screw cap. The first container may be labeled Bottle A.

The second solution is aseptically filled into the second container 26, such as a pre-sterilized borosilicate, Type I, glass vial, which is secured with a pre-sterilized Stelmi septum, which is held in place with a tear-off seal. The tear-off seal is crimped to the bottle using a validated crimping process as the manufacturer's recommended crimp setting. The second container may be labeled Bottle B. Bottle B is de-gassed with Argon gas during the mixing and filling process to reduce the presence of oxygen. Bottle B is then placed in a pouch 28, such as a Mylar pouch filled with Argon gas and an oxygen absorber 28, to reduce oxygen exposure during its shelf life. The bottle and pouch are then labeled.

The first container 22 containing the first solution and the pouch 28 containing the second container containing the second solution are then placed in a package, such as a cardstock preprinted box. The package insert is also placed in the package and the box is sealed and labeled for distribution.

Exemplary embodiments of the kit will produce about 1 liter of the final formulation and will be in about 950 milliliters of the first solution and about 50 milliliters of the second solution. While it is expected that the mixture of the first and second solutions provided in the kit will result in a mixture having the desired physiological pH, the kits could optionally include a device for measuring the pH of the mixture, such as litmus paper, and a set of pH adjusting agents, i.e., a base (e.g., 84% aqueous solution of NaHCO₃) and an acid (e.g., 4N HCl), for adjusting the pH of the mixture to result in a final formulation having the desired physiological pH.

Tables 1 and 2 provide specific composition for a first embodiment of the first and second solutions.

TABLE 1
components of the first embodiment of first solution

| COMPONENT | CONCENTRATION (mmol/L) |
|---|---|
| Calcium chloride dehydrate | 1.30 |
| Potassium chloride | 7.00 |
| Potassium phosphate, monobasic | 0.44 |
| Magnesium chloride, hexahydrate | 0.50 |
| Magnesium sulfate, heptahydrate | 0.50 |
| Sodium chloride | 125.00 |
| Sodium bicarbonate | 5.00 |
| Sodium phosphate, dibasic heptahydrate | 0.19 |
| D-Glucose | 11.00 |
| Adenosine | 2.00 |
| Orotic acid | 0.50 |
| Malic acid | 1.00 |
| L-Carnitine | 10.00 |
| Sodium dichloroacetate | 0.50 |
| Water for Injection | n/a |
| Insulin | 100 unitsl/L |
| Optional KCl (for use in cardioplegia) | 15.00 |
| pH | 8.96 ± 0.01 |
| Color | clear |

Other salts than listed can be used or the source of the active ions provided in the above formulations.

TABLE 2
solution B (20x)

| COMPONENT | CONCENTRATION (mmol/L) |
|---|---|
| L-Glutathione reduced | 20.00 |
| L-Ascorbiv acid | 20.00 |
| L-Citrulline | 20.00 |
| Creatine monohydrate | 40.00 |
| L-Carnosine | 200.00 |
| L-Arginine | 100.00 |
| Water for Injection | n/a |
| Sterile Argon gas | Sat* |
| pH | 6.61 ± 0.04 |
| Color | clear |

Tables 3 and 4 provide specific composition for an alternative embodiment of the first and second solutions.

TABLE 3
The following is an alternative embodiment of the first solution:

| COMPONENT | CONCENTRATION (mM) |
|---|---|
| Calcium chloride dehydrate | 1.30 |
| Potassium chloride | 7.00 |
| Potassium phosphate, monobasic | 0.44 |
| Magnesium chloride, hexahydrate | 0.50 |
| Magnesium sulfate, heptahydrate | 0.50 |
| Sodium chloride | 125.00 |
| Sodium bicarbonate | 5.00 |
| Sodium phosphate, dibasic heptahydrate | 0.19 |
| D-Glucose | 11.00 |
| Adenosine | 2.00 |
| Orotic acid | 0.50 |
| Malic acid | 1.00 |
| L-Carnitine | 10.00 |
| Water for Injection | n/a |
| Insulin | 100 units/L |
| Optional KCl (for use in cardioplegia) | 15.00 |
| pH | 8.96 ± 0.01 |
| Color | clear |

TABLE 4
Solution B (20x)

| COMPONENT | CONCENTRATION (mM) |
|---|---|
| L-Glutathione reduced | 1.00 |
| L-Ascorbic acid | 1.00 |
| L-Citrulline | 1.00 |
| Creatine monohydrate | 2.00 |
| L-Carnosine | 10.00 |
| L-Arginine | 5.00 |
| Water for Injection | n/a |
| Sterile Argon gas | Sat* |
| pH | 6.61 ± 0.04 |
| Color | clear |

The formulations and methods described herein are not limited to use with a particular tissue, organ, or cell type. For example, embodiments of the invention may be used with harvested saphenous veins, epigastric arteries, gastroepiploic arteries, and radial arteries used in coronary bypass grafting. Embodiments of the present invention may also be used to maintain organs and tissue during transplant operations. Is it contemplated that embodiments of the invention may be used with organs and tissues that include, but are not limited to, heart, lung, kidney, brain, muscle, grafts, skin, intestine, bone, teeth, appendages, eyes, and portions thereof. Embodiments of the invention may be used as an in situ tissue or organ preservative. Embodiments of the invention may also be used to wash or bathe tissues and organs that have not been removed from a subject. For example, embodiments of the invention may be used to maintain tissues and organs during cardioplegia. Embodiments of the invention may also be used in emergency procedures where a tissue or organ needs to be bathed in the formulations to preserve its function until surgery or other medical attention can be obtained. In this regard, embodiments of the invention may be available to emergency medical personnel both in hospital settings and “in the field” (i.e., in ambulances or temporary emergency medical facilities).

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. For example, the formulations may be in the form of a liquid, gel, cream, hydrogel. Accordingly, departures may be made from such details without departing from the scope or spirit of the general inventive concept.

What is claimed is:

1. A kit for preserving the function of a tissue or organ comprising:
a first container containing a first solution, wherein the first solution is comprised of water, a balanced salt solution, a sugar, adenosine, orotic acid, malic acid, and L-carnitine and has a pH of at least 7;
a second container containing a second solution, wherein the second solution is comprised of water, an antioxidant, a reducing agent, L-citrulline, creatine, L-carnosine, and L-arginine and has a pH of below 7.

2. The kit according to claim 1 wherein the balanced salt solution includes salts selected from the group consisting of calcium chloride dihydrate, potassium chloride, potassium phosphate monobasic, magnesium chloride hexahydrate, magnesium sulfate heptahydrate, sodium chloride, sodium bicarbonate, sodium phosphate dibasic heptahydrate and combinations thereof.

3. The kit according to claim 1 wherein the balanced salt solution about 0.2 grams/liter calcium chloride dihydrate, about 0.5 grams/liter potassium chloride, 0.06 grams/liter potassium phosphate monobasic, about 0.1 grams/liter magnesium chloride hexahydrate, about 0.12 grams/liter magnesium sulfate heptahydrate, about 7.3 grams/liter sodium chloride, about 0.4 grams/liter sodium bicarbonate, and about 0.05 grams/liter sodium phosphate dibasic heptahydrate.

4. The kit according to claim 1 wherein the second solution includes about 50 milliliters of water, about 0.31 grams of reduced L-glutathione, about 0.18 grams of L-ascorbic acid, about 0.18 grams of L-citrulline, about 0.3 grams of creatine monohydrate, about 2.26 grams of L-carnosine, and about 0.87 grams of L-arginine.

5. The kit according to claim 1 wherein the volumetric ratio of the first solution to the second solution is about 19:1.

6. The kit according to claim 1 wherein the pH of the first solution is in a range from about pH 7 to about pH 9.

7. The kit according to claim 1 wherein the pH of the second solution is in a range from about pH 6.4 to about pH 6.8.

8. The kit according to claim 1 wherein the mixture of the first solution with the second solution forms a final formulation with a pH in a range from about pH 7.2 to about pH 7.6.

9. The kit of claim 1 wherein the kit includes a single container comprising a first compartment and a second compartment, wherein the first compartment is the first container containing the first solution and the second compartment is the second container containing the second solution, wherein the first and second compartments are maintained as separate compartments by a partition that may be removed to allow the first and second solutions to mix to form a final formulation for preserving the function of a tissue or organ.

10. A method of preparing a formulation for preserving the function of a tissue or organ comprising:
providing a first solution wherein the first solution includes water, a balanced salt solution, a sugar, adenosine, orotic acid, malic acid, and L-carnitine and has a pH of at least 7;
providing a second solution, wherein the second solution includes water, an antioxidant, a reducing agent, L-citrulline, creatine, L-carnosine, and L-arginine and has a pH of below 7; and
mixing the first solution with the second solution to form the complete formulation for preserving the function of a tissue or function.

11. The method of claim 10 wherein the balanced salt solution includes salts selected from the group consisting of calcium chloride dihydrate, potassium chloride, potassium phosphate monobasic, magnesium chloride hexahydrate, magnesium sulfate heptahydrate, sodium chloride, sodium bicarbonate, sodium phosphate dibasic heptahydrate.

12. The method of claim 10 wherein wherein the balanced salt solution includes about 0.2 grams/liter calcium chloride dihydrate, about 0.5 grams/liter potassium chloride, 0.06 grams/liter potassium phosphate monobasic, about 0.1 grams/liter magnesium chloride hexahydrate, about 0.12 grams/liter magnesium sulfate heptahydrate, about 7.3 grams/liter sodium chloride, about 0.4 grams/liter sodium bicarbonate, and about 0.05 grams/liter sodium phosphate dibasic heptahydrate.

13. The method of claim 10 wherein the second solution consists essentially of 50 milliliters of water, about 0.31 grams of reduced L-glutathione, about 0.18 grams of L-ascorbic acid, about 0.18 grams of L-citrulline, about 0.3 grams of creatine monohydrate, about 2.26 grams of L-carnosine, and about 0.87 grams of L-arginine.

14. The method of claim 10 wherein the volumetric ratio of the first solution to the second solution is about 19:1.

15. The method of claim 10 wherein the pH of the first solution is in a range from about pH 7 to about pH 9.

16. The method of claim 10 wherein the pH of the second solution is in a range from about pH 6.4 to about pH 6.8.

17. The method of claim 10 wherein the pH of the mixture of the first solution with the second solution is in a range from about pH 7.2 to about pH 7.6.

18. The method of claim 10 further comprising:
providing a container having a first compartment and a second compartment that maintained as separate compartments by a partition, wherein the first compartment includes the first solution and the second compartment includes the second solution;
removing the partition to allow the first and second solutions to mix to form a complete formulation for preserving the function of a tissue or organ.

19. The method of claim 10 further comprising:
providing a first container that includes the first solution;
providing a second container that includes the second solution;
mixing the contents of the second container with the contents of the first container to form a complete formulation for preserving the function of a tissue or organ.

20. A method of preserving the function of a tissue or organ comprising:
providing a first solution wherein the first solution includes water, a balanced salt solution, a sugar, adenosine, orotic acid, malic acid, and L-carnitine and has a pH of at least 7;
providing a second solution, wherein the second solution includes water, a reducing agent, and an antioxidant, L-citrulline, creatine monohydrate, L-carnosine, and L-arginine and has a pH of below 7;
mixing the first solution with the second solution to form the complete formulation for preserving the function of a tissue or function; and
contacting a tissue or organ with the complete formulation.
